(19) United States
(12) Patent Application Publication
(10) Pub. No.: US 2025/0309534 A1
(43) Pub. Date: Oct. 2, 2025

(54) ANTENNA CIRCUIT BOARD AND ANTENNA MODULE WITH PLURAL FREQUENCY BANDS

(71) Applicants: FOXCONN (KUNSHAN) COMPUTER CONNECTOR CO ., LTD., Kunshan (CN); FOXCONN INTERCONNECT TECHNOLOGY LIMITED, Grand Cayman (KY)

(72) Inventors: KUN-RONG LIN, New Taipei (TW); Yu-Jen Chen, New Taipei (TW); Lung-Sheng Tai, New Taipei (TW); Chun-Ta Lee, New Taipei (TW)

(21) Appl. No.: 19/093,883

(22) Filed: Mar. 28, 2025

(30) Foreign Application Priority Data
Mar. 30, 2024 (CN) 202420646379.2

(51) Int. Cl. H01Q 5/25; H01Q 1/48; H01Q 5/10; H01Q 5/50

(52) U.S. Cl. CPC H01Q 5/25; H01Q 1/48; H01Q 5/10; H01Q 5/50

(57) ABSTRACT

An antenna module includes: a frame; a circuit board on an upper side of the frame, which defines an upper and a lower face, a first side edge and having a first and a second radiator area at the upper face; a lower bracket on a lower side of the frame, wherein the first radiator area comprises a first current path and plural signal feeding points, the second radiator area comprises a second current path close to the first side edge, and plural first grounding feeding points, the second and the third current path extend in two different directions, the second current path is spaced away from the first side edge by a first gap, the first, second and third current path transmit signals in three different frequency bands, and the first radiator area is connected to the second radiator area by a fourth current path.

### BACKGROUND OF THE INVENTION

### Field of the Invention

The present invention relates to an antenna module with different frequency bands.

### Description of Related Arts

U.S. Pat. No. 11,581,628 discloses an antenna structure which comprises a first radiator, a second radiator, an antenna ground and a conductor. The first radiator is used for resonating at a high frequency band and the second radiator is used for resonating at a low frequency band. The antenna structure has only two frequency bands and may not meet three-bands signal transmission requirements of WI-FI 6e.

Therefore, it is necessary to provide an antenna module with plural frequency bands.

### SUMMARY OF THE INVENTION

The object of the present invention is to provide an antenna module with plural frequency bands.

To achieve the above object, an electrical connector comprises: a frame; a circuit board located on an upper side of the frame, the circuit board defining an upper face, a lower face, a first side edge, and a second side edge and having a first radiator area and a second radiator area located at the upper face; and a lower bracket located on a lower side of the frame, wherein the first radiator area comprises a first current path and plural signal feeding points, the second radiator area comprises a second current path close to the first side edge, a third current path, and plural first grounding feeding points, the second current path and the third current path extend in two different directions respectively, the second current path is spaced away from the first side edge by a first gap, the first current path, the second current path, and the third current path are able to transmit signals in three different frequency bands respectively, and the first radiator area is connected to the second radiator area by a fourth current path.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an antenna module of an embodiment of this present invention;

FIG. 2 is a top view of an antenna circuit board of the antenna module in FIG. 1; and

FIG. 3 is a bottom view of the antenna circuit board of the antenna module in FIG. 1.

### DETAILED DESCRIPTION OF THE PREFERRED EMBODIMENT

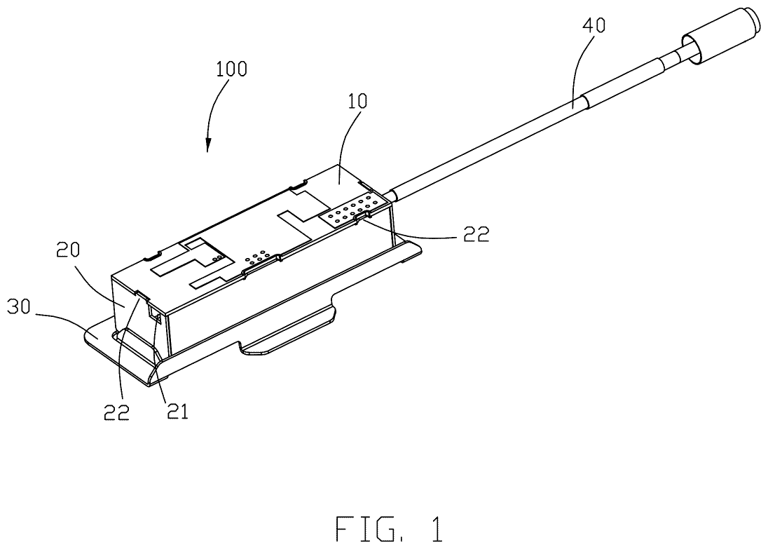

Referring to FIGS. 1-3, an antenna module 100 of one embodiment of this invention is illustrated. The antenna module 100 comprises an antenna circuit board 10, a frame 20 with plural sides, and a bracket 30. The antenna circuit board 10 is located at an upper side of the frame 20 and the bracket 30 is located at a lower side of the frame 20. The frame 20, the antenna circuit board 10, and the bracket 30 form a resonant cavity thereamong. The frame 20 is made from metal material. The antenna circuit board 10 comprises a substrate 11, and a first radiator area 12 and a second radiator area 13 that are located on an upper face 118 of the substrate 11. The first radiator area 12 and the second radiator area 13 are connected with each other and can radiate signals at two different frequency bands. The first radiator area 12 comprises a first current path 121 and plural signal feeding points 114 connected to the first current path 121. The second radiator area 13 comprises plural feeding points 115, a second current path 131 and a third current path 132. The first radiator area 12 and the second transmitting area 13 are connected by a fourth current path 14 as a whole. The second current path 131 is spaced with a first side edge/back side edge of the substrate 11 by a first gap 111, the first gap 111 acting to effect an electric capacitance. In cooperation with a resonance generated by the frame 20, the second current path 131 can transmit signals at a frequency band different from the frequency bands at which the first current path 131 and the third current path 131 transmit signals by altering the first gap 111, and thus, the antenna module 100 is able to transmit signals at three different frequency bands by the first current path 121, the second current path 131, and the third current path 132 to meet a transmission requirement of WI-FI 6e.

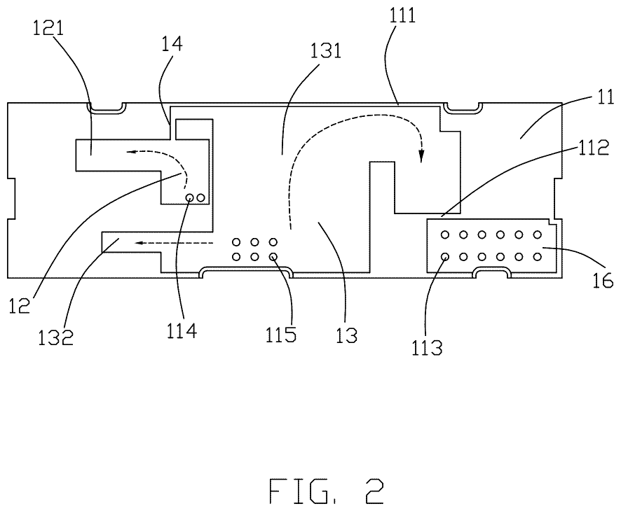

Referring to FIGS. 1-2, the main working frequency bands of WI-FI 6e are 2.4 GHz, 5 GHZ, and 6 GHz. Preferably, the first current path 121 is adapted for controlling a current resonant path in quarter-wavelength and at 5 GHz frequency band, the second current path 131 is adapted for controlling a current resonant path in quarter-wavelength and at 2.4 GHz frequency band, and the third current path 132 is adapted for controlling a current resonant path in quarter-wavelength and at 6 GHz frequency band. Since the lower the frequency of the signal is, the longer the wavelength of the signal is, the second current path 131 has a longest length and the third current path 132 has the shortest length.

In this embodiment, the substrate 11 extends along a longitudinal direction and has two opposite long side edges, namely, the first side edge/back side edge and a second side edge/front side edge. The first current path 121 and the third current path 132 are arranged in parallel along a lateral direction/front-rear direction perpendicular to the longitudinal direction, and the second current path 131 is arranged side-by-side with the first current path 121 and the third current path 132 along the longitudinal direction, that is, the third current path 132 is opposite to both the first current path 121 and the third current path 132 in the longitudinal direction. The first current path 121 is closer to the first side edge and the third current path 132 is closer to the second side edge, and two side edges of the second current path 131 are closer to the corresponding first side edge and the second side edge respectively, making a layout of the first radiator area 12 and the second transmitting area 13 more compact. Preferably, the first current path is L shaped, and the third current path 132 extends from the second current path 131. The signals in the third current path 132 are transmitted along the longitudinal direction away from the second current path 131; the signals in the first current path 132 are transmitted along the lateral direction toward the first side edge of the substrate 11 first, and then along the longitudinal direction away from the second current path 131; the signals in the second current path 131 are transmitted along the lateral direction from the second side edge to the first side edge first, and then along the longitudinal direction away from the first current path 121 secondly, and along the lateral direction from the first side edge to the second side edge first at last.

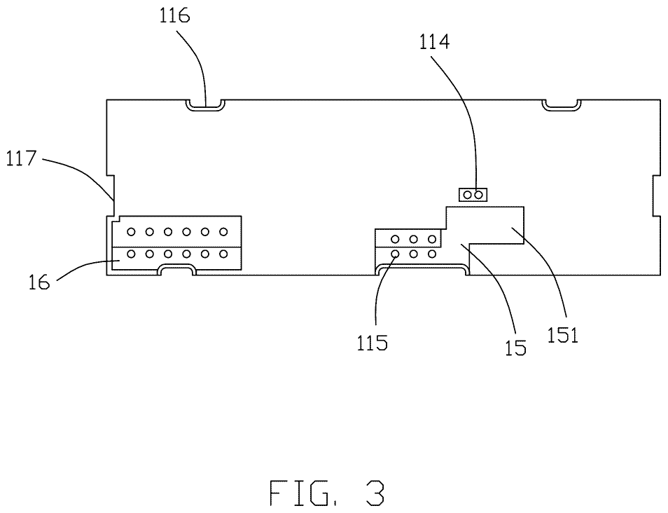

Referring to FIGS. 2-3, the signal feeding points 114 extend from the upper face 118 of the substrate 11 to a lower face of the substrate 11, so the signal feeding points 114 expose to both the upper face and the lower face of the substrate 11. The signal feeding points 114 are connected to a core portion of a cable 40. The second current path 121 are provided with plural first grounding feeding points 115, the first grounding feeding points 115 are close to both the second side edge of substrate 11 and the third current path 132. The antenna circuit board 10 further comprises a third radiator area 15 which is at least partially overlapped with the second transmitting area 13. The third radiator area 15 comprises the first grounding feeding points 115 and a fifth current path 151. Similar to the signal feeding points 114, the first grounding feeding points 115 extend from the upper face 118 of the substrate 11 to a lower face of the substrate 11 and exposes to both at the upper face and the lower face of the substrate 11. In other embodiments, the first grounding feeding points 115 exposing to the upper face 118 of the substrate 11 and the lower face of the substrate 11 can also be connected by other means, e.g., the feeding points exposing to the upper face 118 of the substrate 11 and the lower face of the substrate 11 are connected by through holes with conductive plating. The first grounding feeding points 115 are connected to a shielding portion of the cable 40. The antenna circuit board 10 further comprises two feeding plates 16 overlapped with each other in an upper and lower direction, and the feeding plates 16 are close to both the second side edge and a right edge of the antenna circuit board 10; one feeding plate 16 is located at the upper face of the substrate 11 and the other is located at the lower face of the substrate 11. The two feeding plates are provided with plural second grounding feeding points 113 going through the two feeding plates 16 and the substrate 11 between the two feeding plates 16. Similar to the first grounding feeding points 115, the second grounding feeding points 113 at the two feeding plates 16 can also be connected by through holes with conductive plating. The shielding portion of the cable 40 are connected to the second grounding feeding points 113 of the feeding plate 16 at the lower face of the substrate 11 first, and then are connected to the first grounding feeding points 115 of the third radiator area 15. In this embodiment, the feeding plate 16 at the upper face of the substrate 11 is adjacent to the second current path 131 and is spaced with the second path 131 by a second gap 112 in the lateral direction.

Referring to FIGS. 1-3, the antenna circuit board 10 comprises at least one welding slot 116 and one positioning slot 117, the frame 20 has plural bumps 22, the bumps 22 are adapted for cooperating with the welding slot 116 and the positioning slot 117 one by one. The frame 20 is configured as a cuboid. Two bumps protrudes upwardly from a left side edge and the right side edge of the frame 20 and go through two positioning slots 117 at two short edges of the antenna circuit board 10 correspondingly. Plural bumps 22 protrude upwardly from a front side edge and a back side edge of the frame 20 and go through the welding slots 116 at the two long edges of the antenna circuit board 10 one by one correspondingly.

An assembling process of the antenna circuit board 10 will be briefly introduced hereinafter. Firstly, the cable 40 is received in an opening 21 at the right side of the frame 20 after the cable 40 is connected to the feeding points. Secondly, the bumps 22 is fixed into the corresponding positioning slots 117 and the bumps 22 is welded to the corresponding welding slots 116. In this embodiment, both the right side and the left side of the frame 20 have the openings 21, and thus, the cable 40 can be received in the opening 21 at the right side or the left side as needed. The second current path 131 is gapped with the first side edge of the substrate 11 by the first gap 111 and is gapped with the corresponding feeding plate 16 by the second gap 112. The working frequency band of the second current path 131 may be adjusted by change of a length or a width of the first gap 111. The length of the first gap 111 should be increased in proportion to the width of the first gap 111 when the width of the first gap 111 is increased to adjust the working frequency band of the second current path 131 at 2.4 GHz. The working frequency band of the second current path 131 can not reach 2.4 GHz if the length of the first gap 111 is not increased in proportion to the width of the first gap 111. Preferably, the second current path 131 is closer to the first side edge of the substrate 11 as possible to minimize the width of the first gap 111, and then adjust the length of the first gap and the second current path 131 to optimize the receiving and sending effect of the second current path 131 at 2.4 GHz working frequency band. The working frequency band of the antenna circuit board 10 may be changed between a high frequency band and a low frequency band by adjusting the second gap 112. Alternatively, the first radiator area 12 and the second radiator area 13 are set at the lower face of the of the substrate 11 while the third radiator area 15 is set at the upper face of the substrate 11, and the antenna module 100 is able to transmit signals in three different frequency bands by the first current path 121, the second current path 131, and the third current path 132.

The above-mentioned embodiments are only preferred embodiments of the present invention, and should not limit the scope of the present invention, any simple equivalent changes and modifications made according to the claims of the present invention and the contents of the description should still belong to the present invention.

1. An antenna module comprising:
a frame;
a circuit board located on an upper side of the frame, the circuit board defining an upper face, a lower face, a first side edge, and a second side edge and having a first radiator area and a second radiator area located at the upper face; and
a lower bracket located on a lower side of the frame;
wherein the first radiator area comprises a first current path and plural signal feeding points, the second radiator area comprises a second current path close to the first side edge, a third current path, and plural first grounding feeding points, the second current path and the third current path extend in two different directions respectively, the second current path is spaced away from the first side edge by a first gap, the first current path, the second current path, and the third current path are able to transmit signals in three different frequency bands respectively, and the first radiator area is connected to the second radiator area by a fourth current path.

2. The antenna module as claimed in claim 1, wherein the first current path, the second current path, and the third current path are adapted for controlling current resonant paths in quarter-wavelength and at 5 GHz frequency band, in quarter-wavelength and at 2.4 GHz frequency band, and in quarter-wavelength and at 6 GHz frequency band, respectively.

3. The antenna module as claimed in claim 1, wherein the circuit board comprises a third radiator area located at the lower face, the third radiator area is at least partially overlapped with the second radiator area, and the first grounding feeding points extend from the second radiator area to the third radiator area by going through the circuit board in an upper and lower direction.

4. The antenna module as claimed in claim 3, wherein the third radiator area comprises a fifth current path acting to effect an electric capacitance for the third current path and the fourth current path to adjust the frequency bands of the third current path and the fourth current path.

5. The antenna module as claimed in claim 1, wherein the signal feeding points and the first grounding feeding points extend from the upper face of the circuit board to the lower face of the circuit board by going through the circuit board in an upper and lower direction.

6. The antenna module as claimed in claim 1, wherein the first side edge and the second side edge of the circuit board extend along a longitudinal direction, the first current path and the third current path are arranged in parallel along a lateral direction perpendicular to the longitudinal direction, and the second current path are arranged side-by-side with both the first current path and the third current path along the longitudinal direction.

7. The antenna module as claimed in claim 6, wherein the fourth current path is close to the first side edge, and the first gap acts to effect an electric capacitance for the second current path to adjust the frequency band of the second current path.

8. The antenna module as claimed in claim 1, further comprising a feeding plate with plural second grounding feeding points and located on the upper face of the circuit board, and wherein the feeding plate is close to the second side edge of the circuit board and is spaced with a free end of the second current path by a second gap, and the second gap acts to effect an electric capacitance for adjusting a working frequency band of the antenna module.

9. The antenna module as claimed in claim 8, further comprising a cable, and wherein the signal feeding points are connected to a core portion of a cable, and the first grounding feeding points and the second grounding feeding points are connected to a shielding portion of the cable.

10. The antenna module as claimed in claim 9, wherein both a right side and a left side of the frame have openings, and the cable is received in one of the openings.

11. An antenna module comprising:
a frame;
a circuit board located on an upper side of the frame and extending in a first direction and a second direction perpendicular to each other, the circuit board comprising a first radiator area and a second radiator area located on an upper face thereof and spaced from each other in the first direction; and
a lower bracket located on a lower side of the frame;
wherein the first radiator area comprises a first current path and plural signal feeding points; the second radiator area comprises a second current path, a third current path, and plural first grounding feeding points, the second current path is spaced away from a first side edge of the circuit board in the second direction by a first gap, the first current path and the third current path are arranged in parallel, and the second current path is arranged side-by-side with both the first current path and the third current path along the first direction, and signals transmitted by the first current path, the second current path, and the third current path are different from each other; and the first radiator area is connected to the second radiator area by a fourth current path.

12. The antenna module as claimed in claim 11, wherein the signals in the third current path are transmitted along the first direction away from the second current path.

13. The antenna module as claimed in claim 12, wherein the first current path transmits signals along the second direction and toward the first side edge of the circuit board firstly and then along the first direction away from the second current path.

14. The antenna module as claimed in claim 13, wherein the second current path transmits signals along the second direction from the second side edge to the first side edge first, then along the first direction away from the first current path secondly, and along the second direction from the first side edge to the second side edge at last.

15. An antenna circuit board comprising:
a substrate extending in a first direction and a second direction; and
a first radiator area and a second radiator area located on an upper face of the substrate and space from each other in the first direction;
wherein the first radiator area comprises a first current path and plural signal feeding points; the second radiator area comprises a second current path, a third current path and plural first grounding feeding points, the second current path is spaced away from a first side edge of the substrate in the second direction by a first gap, the first current path and the third current path are arranged in parallel, and the second current path is arranged side-by-side with both the first current path and the third current path along the first direction, and signals transmitted by the first current path, the second current path, and the third current path are different from each other; and the first radiator area is connected to the second radiator area by a fourth current path.
